(19) United States
(12) Patent Application Publication
(10) Pub. No.: US 2021/0150474 A1
(43) Pub. Date: May 20, 2021

(54) COMPUTER IMPLEMENTED SYSTEMS AND METHODS FOR EFFICIENT DISTRIBUTION OF ORDERS BASED ON SYSTEM PARAMETERS

(71) Applicant: COUPANG CORP., Seoul (KR)

(72) Inventors: Sung Jin Park, Seoul (KR); Sang Ho Yim, Seoul (KR)

(73) Assignee: Coupang Corp.

(21) Appl. No.: 16/687,923

(22) Filed: Nov. 19, 2019

(51) Int. Cl. G06Q 10/08

(52) U.S. Cl. CPC G06Q 10/0875; G06Q 10/0833

(57) ABSTRACT

A computer-implemented system for efficient distribution of orders based on system parameters is disclosed. The system may comprise a memory storing instructions; and at least one processor configured to execute the instructions. The instructions may comprise: aggregating one or more orders comprising one or more quantities of a plurality of items; assigning a subset of the items to a batch, wherein the items are assigned to one or more batches; determining one or more parameters of a transporting system for the batches; determining at least one of location or orientation of the items in the transporting system based on the parameters of the transporting system; and transmitting, to a user device for display, the parameters of the transporting system.

### TECHNICAL FIELD

The present disclosure generally relates to computerized methods and systems for distributing customer orders based on system configurations and limitations. In particular, embodiments of the present disclosure relate to inventive and unconventional systems that disassemble a set of orders into individual items for retrieval while accounting for system configurations such as the items' locations and limitations such as weight limits of transporting systems.

### BACKGROUND

With proliferation of the Internet, online shopping has become one of the major avenues of commerce. Consumers and businesses are purchasing goods from online vendors more frequently than ever, and the number of transactions and sales revenue are projected to grow year-over-year at a staggering rate. As the scope and volume of e-commerce continue to grow, both a number of different products available online and an average number of purchases made in a given period are growing exponentially. It has thus become very important to optimize processes of fulfilling an order, which starts when a customer places an order and ends when the order is delivered to the customer.

Of the different processes that are involved such as retrieving items included in the order, packaging the items, and shipping, various solutions for retrieving the items already exist to make the process more efficient. The existing solutions, however, are rudimentary in that they control the retrieving tasks on a per-order basis. That is, under existing solutions, workers are assigned orders and they retrieve items until they complete retrieving every item in each order, regardless of where the items may be located in a warehouse. Considering the numerosity of items and a typical size of a large warehouse, the existing solutions may not be utilizing the workers' time and effort as much as they could. This is especially true when different items in an order are located far apart in a warehouse. Moreover, the workers in the existing solutions may not be aware of certain limitations in the overall system, where, for example, a conveyor belt may have certain weight limit. It is nearly impossible for individual workers to account for these limitations as the limit must be calculated based on all products that are in transport at a given point in time, and current systems are unable to account for these limitations as well.

Therefore, there is a need for improved system and methods for managing orders and assigning them to workers in a controlled manner to process the orders in an efficient manner.

### SUMMARY

One aspect of the present disclosure is directed to a computer-implemented system for efficient distribution of orders based on system parameters. The system may comprise a memory storing instructions; and at least one processor configured to execute the instructions. The instructions may comprise: aggregating one or more orders comprising one or more quantities of a plurality of items; assigning a subset of the items to a batch, wherein the items are assigned to one or more batches; determining one or more parameters of a transporting system for the batches; determining at least one of location or orientation of the items in the transporting system based on the parameters of the transporting system; and transmitting, to a user device for display, the parameters of the transporting system.

Yet another aspect of the present disclosure is directed to a computer-implemented method for efficient distribution of orders based on system parameters. The method may comprise: aggregating one or more orders comprising one or more quantities of a plurality of items; assigning a subset of the items to a batch, wherein the items are assigned to one or more batches determining one or more parameters of a transporting system for the batches; determining at least one of location or orientation of the items in the transporting system based on the parameters of the transporting system; and transmitting, to a user device for display, the parameters of the transporting system.

Still further, another aspect of the present disclosure is directed to a computer-implemented system for efficient distribution of orders based on system parameters. The system may comprise a memory storing instructions; and at least one processor configured to execute the instructions. The instructions may comprise: aggregating one or more orders comprising one or more quantities of a plurality of items; assigning a first subset of the items to a first batch, wherein the items are assigned to one or more batches; determining one or more parameters of a transporting system for the first batch; determining at least one of location or orientation of the first set of items in the transporting system based on the parameters of the transporting system; transmitting, to a user device for display, the parameters of the transporting system; receiving, from the user device, a first item identifier associated with a first item among the first subset of items; and transmitting, to the user device for display in response to the first item identifier, at least one of the location or the orientation of the first item as placed in the transporting system.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3A is a diagrammatic illustration of an exemplary picking zone, consistent with the disclosed embodiments.

FIG. 3B is a diagrammatic illustration of a picking operation of a worker in picking zone, consistent with the disclosed embodiments.

FIG. 4 is a schematic block diagram illustrating an exemplary embodiment of a networked environment comprising computerized systems for efficient distribution of orders and dissemination of the same to multiple pickers, consistent with the disclosed embodiments.

FIG. 5 is an illustration of an exemplary order distribution process, consistent with the disclosed embodiments.

FIG. 6 is a schematic block diagram illustrating an exemplary user device, consistent with the disclosed embodiments.

FIG. 7 is a flowchart of an exemplary computerized process for efficient distribution of orders based on system parameters, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to computer-implemented systems and methods for distributing orders based on system parameters by disassembling the orders to individual items and assigning various combinations of the items to workers while accounting for system configurations such as the items' locations and limitations such as weight capacities of transporting systems.

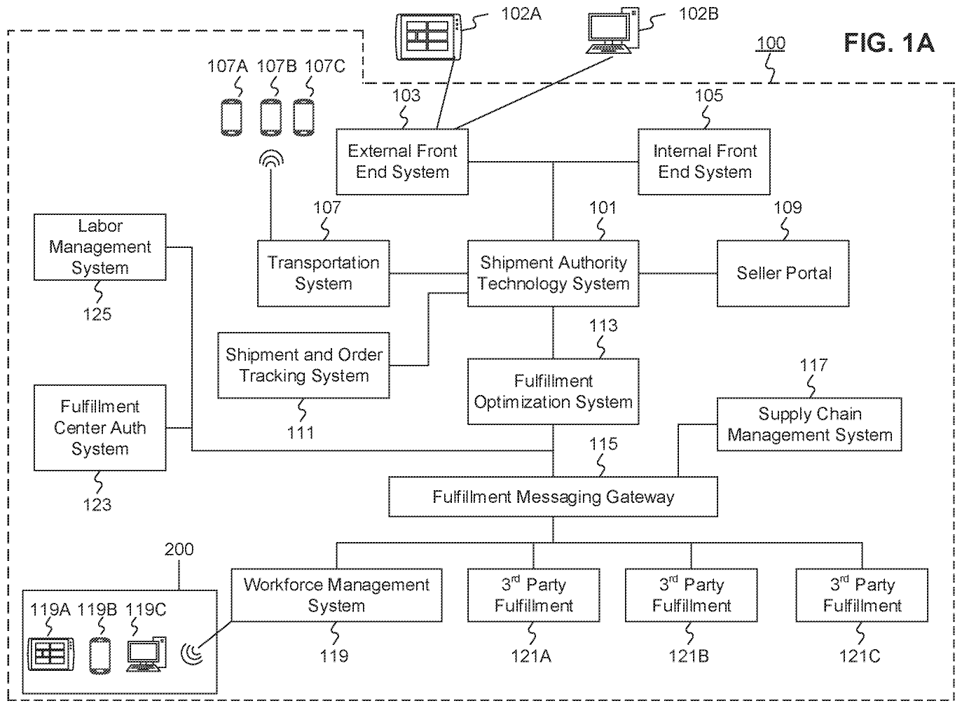

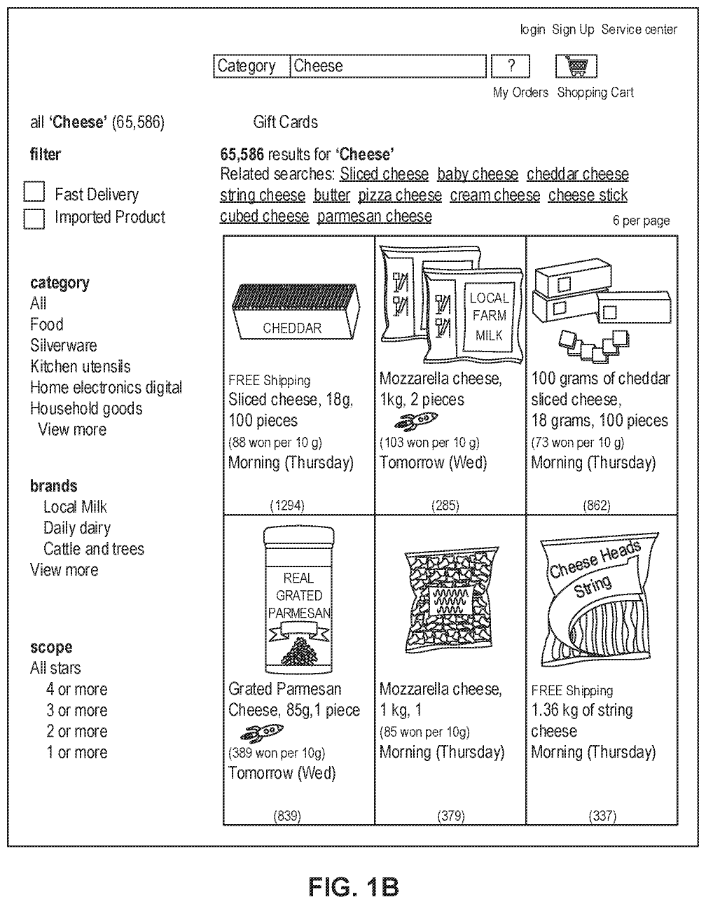

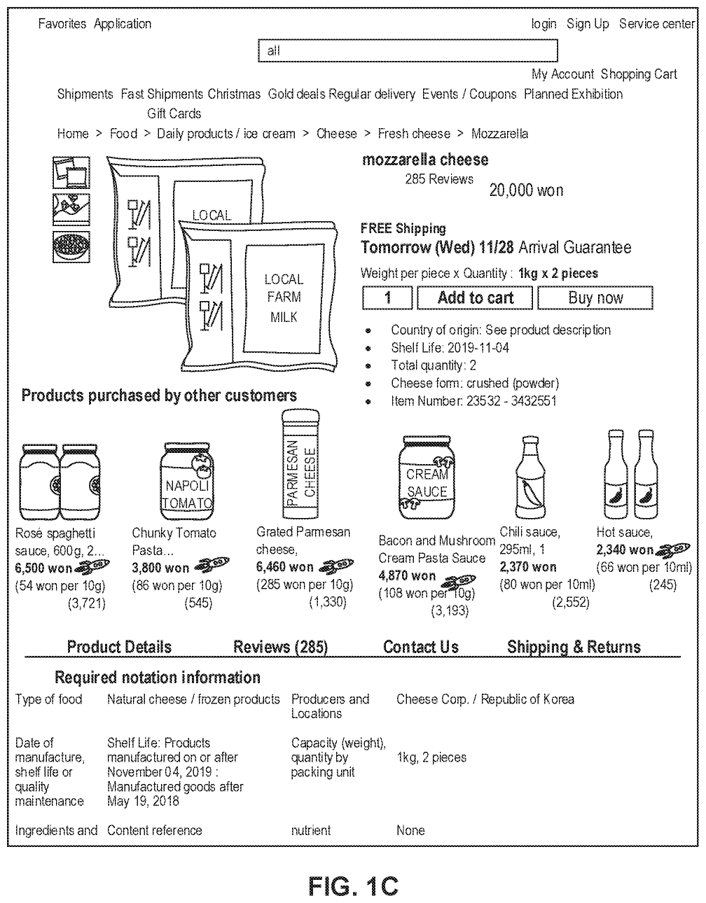

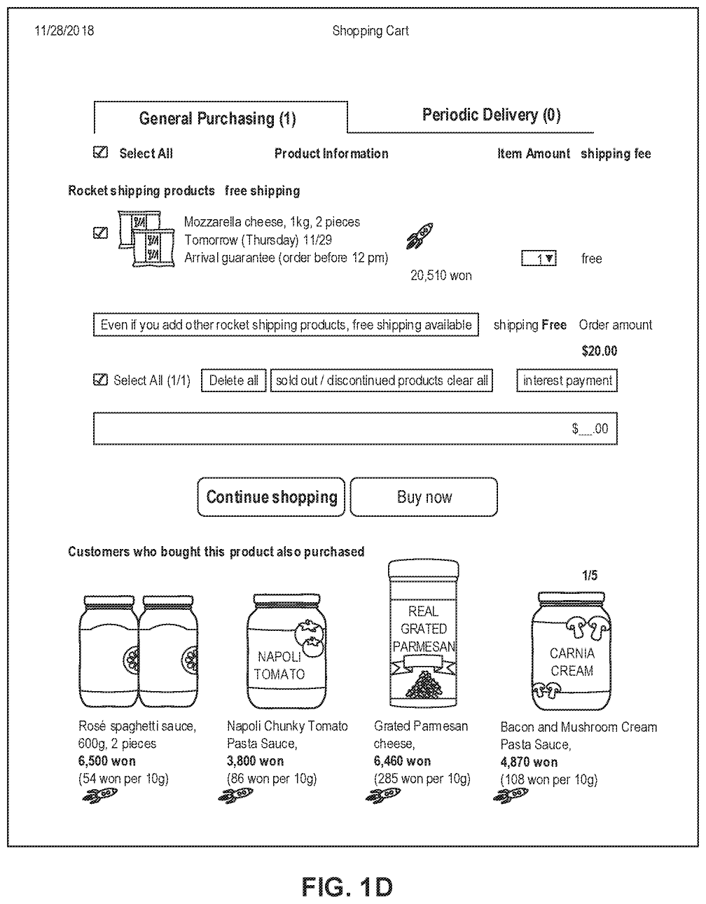

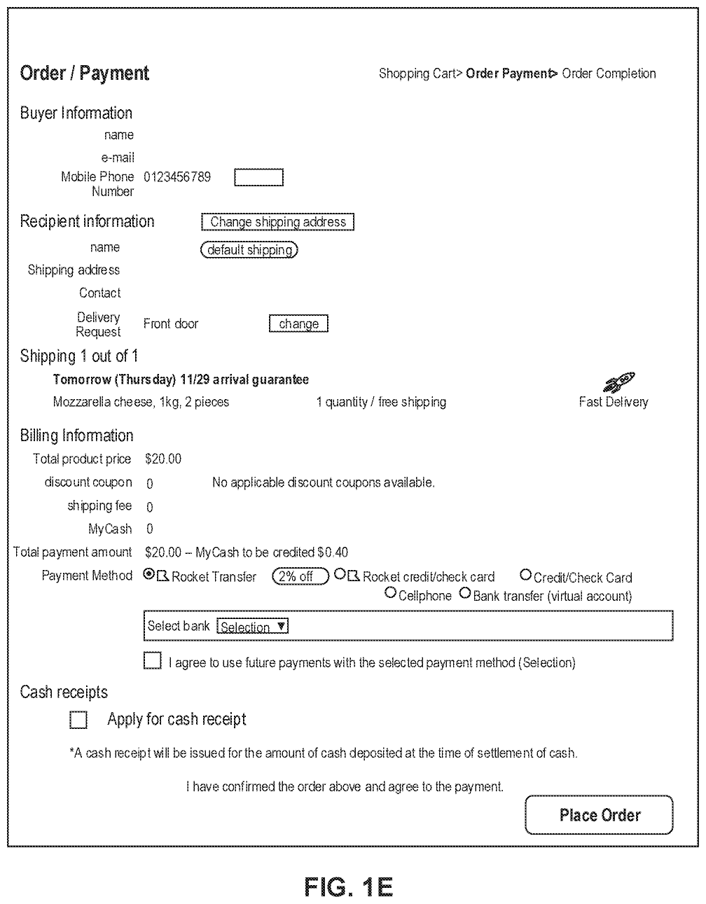

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, workforce management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from workforce management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

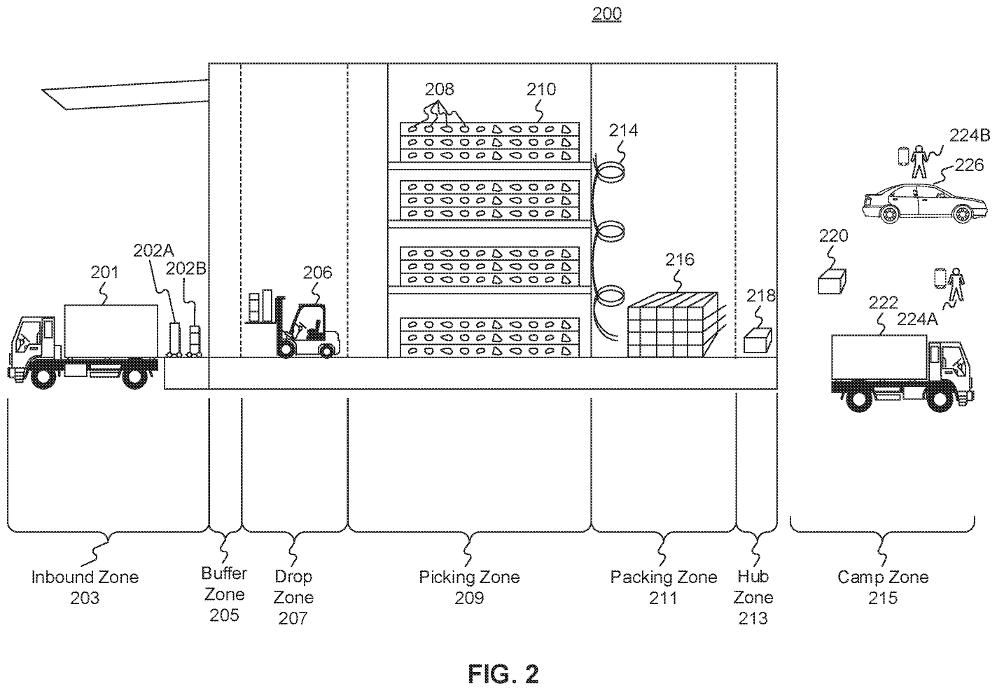

Workforce management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a hand truck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a hand truck, a dolly, an automated robot or device, or manually. For example, a picker may place items 202A and 202B on a hand truck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a hand truck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, hand truck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

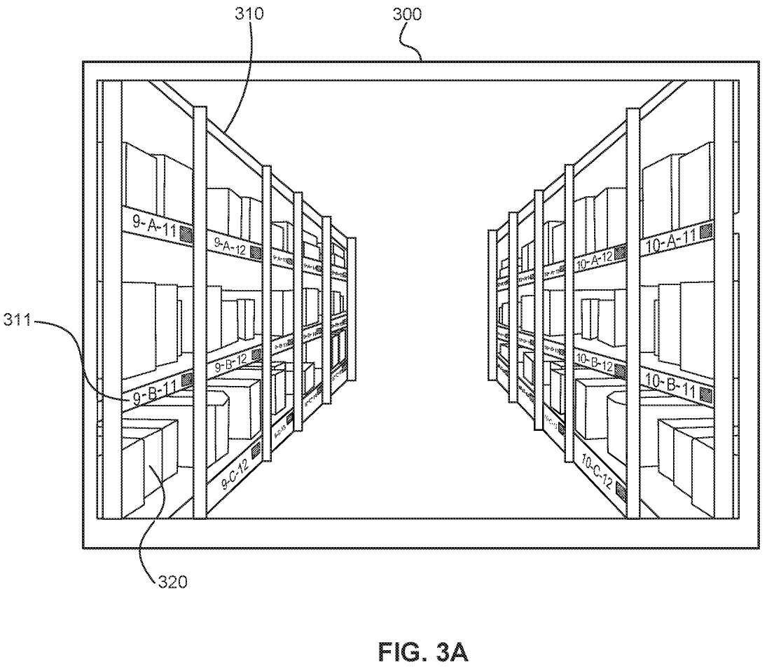

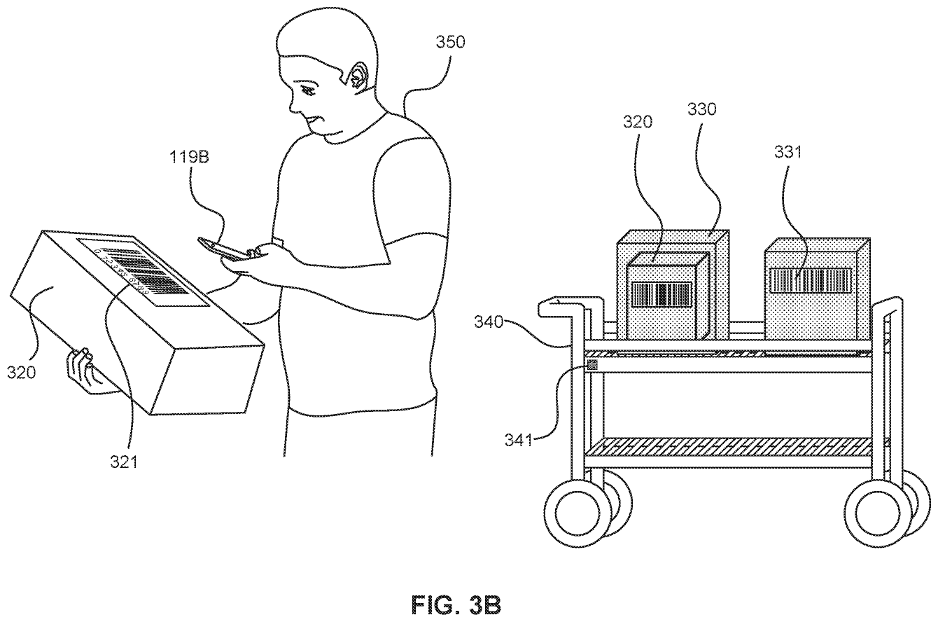

FIG. 3A is a diagrammatic illustration of an exemplary picking zone 300 that may serve a similar function as picking zone 209 of FIG. 2. As shown in FIG. 3A, picking zone 300 may be in a warehouse, such as FC 200. In picking zone 300, items 320 are stored in storage units 310, which may include location identifier 311. Storage units 310, in some embodiments, may be physical shelving, bookshelves, boxes, totes, refrigerators, freezers, cold stores, or the like. Items 320, in some embodiments, may be products for sale and may be picked by a user (such as a picker) or an automated machine, when a customer places an order for items 320 via a website hosted by external front end system 103.

In some embodiments, storage units 310, such as a shelving, may have location identifier 311 attached to it. Location identifier 311 may be a unique address of a particular location of storage units 310 within picking zone 300. In some embodiments, location identifier 311 may correspond to a particular item that is shelved at the location. But in other embodiments, location identifier 311 may indicate multiple items that are shelved together or closely together. Location identifier 311 may be an item barcode, RFID tag, or a matrix barcode, such as Quick Response (QR) code. A camera or a scanner in a user device, such as a mobile device 119B, may scan location identifier 311 using an input device, such as an imaging device including a camera or a scanner. The scanned information may be sent to WMS 119. Based on the scanned information, WMS 119 may determine and confirm whether a picker is at a location that is designated by WMS 119.

A batch may include one or more items. A picker may pick items included in an assigned batch in picking zone 300 until every item in the batch is picked. A picker may move in picking zone 300, such as a warehouse, on foot. In some embodiments, a picker may use other devices that assist movement such as a scooter, a robot and/or vehicles.

In some embodiments, a user device (e.g., mobile device 119B) may assist a picker to find a designated location. In some embodiments, the user device may show a picker a map with navigation. For example, the user device may inform a picker to turn left upon reaching a certain location. In some embodiments, the user device may provide a signal, including, but not limited to a map, sound, vibration or text message for assisting pickers to find a designated location.

FIG. 3B is a diagrammatic illustration of a picking operation of a worker (i.e., a picker 350) in picking zone 300 of FIG. 3A. In some embodiments, item 320 may have item identifier 321 attached to item 320. But in other embodiments, item identifier 321 may not be attached to item 320 and may be located near item 320. Item identifier 321 may comprise one or more of an item barcode, RFID tag, a matrix barcode, such as Quick Response (QR) code, or the like.

A camera or a scanner in a user device, such as mobile device 119B, may scan item identifier 321. The scanned information may be transmitted to WMS 119 via wireless or wired network. Based on the received information, WMS 119 may confirm whether the scanned item identifier 250 matches item identifier information stored in WMS 119. When WMS 119 confirms that it matches, a mobile device 119B may display an instruction to picker 350 to pick item 320 and put it into a container 330. Picker 350 may continue this picking operation until the last item in the batch is picked.

In some embodiments, container 330 may have container identifier 331 attached to container 330. Container 330 may be any holding instrument configured to hold one or more items 320, such as a box, a tote, a bag, or the like. In some embodiments, container 330 may be a compartment in an automated picking machine. Container identifier 331 may comprise one or more of an item barcode, RFID tag, a matrix barcode, such as Quick Response (QR) code, or the like. In some embodiments, there may be more than one type of container 330 that may vary in size, shape, or material. For example, one type of container 330 may be configured specifically for refrigerated items (e.g., produce, meat) and be constructed of an insulating material. The types of containers available at FC 200 may be different, and a particular type available at one FC may not be available at another.

As the items in a batch are picked, picker 350 may place container 330 on a cart 340. In some embodiments, cart 340 may have cart identifier 341 attached to cart 340. Cart 340 may be any vehicle configured to hold and transport one or more containers 330, such as a handcart, a dolly, a drivable cart, or the like. In some embodiments, cart 340 may powered by fuel or electricity. In some other embodiments, cart 340 may be an automated robot designed to move among storage units 310 and pick items 320 using mechanical instruments such as an articulating arm. The types of carts available at FC 200 may be different, and a particular type available at one FC may not be available at another.

After the last item in a batch is picked, picker 350 may move containers 330 to a destination location (e.g., packing zone 211 or transport mechanism 214) using cart 340, in accordance with an instruction displayed in a mobile device 119B. For example, picker 350 may scan a destination identifier by scanning a destination barcode and transmit the scanned information to WMS 119. WMS 119 may share the scanned information with other systems, such as FO system 113 in fulfillment center via wireless or wired network. The sent items may be further processed through the process described above with respect to FIG. 2 and finally sent to customers.

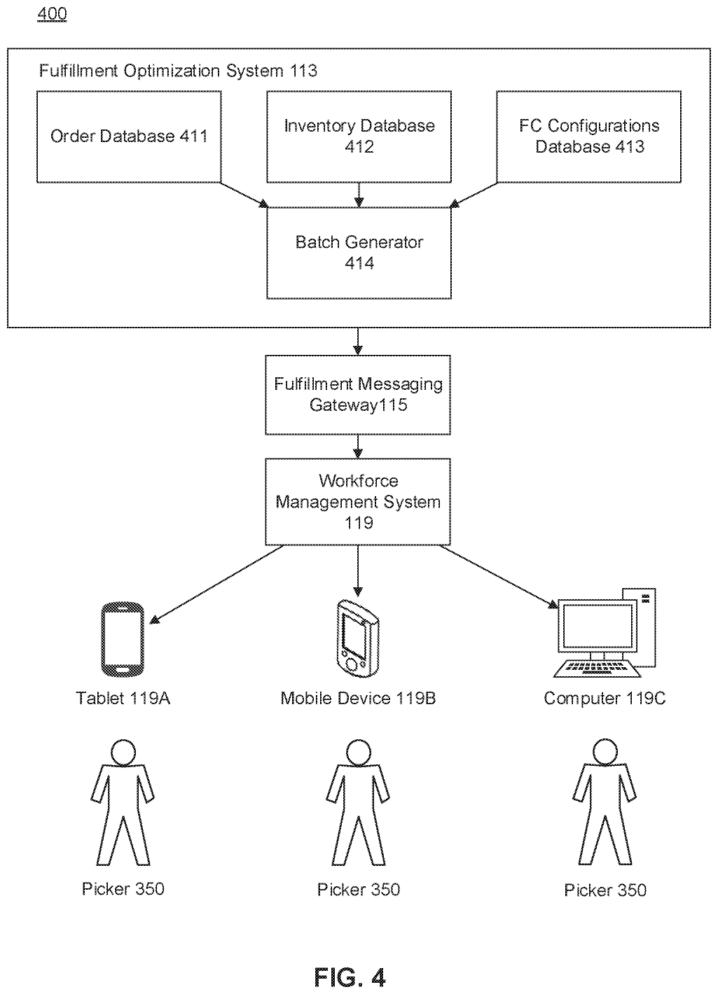

FIG. 4 is a schematic block diagram illustrating an exemplary embodiment of a networked environment 400 comprising computerized systems for efficient distribution of orders and dissemination of the same to multiple users. Environment 400 may include a variety of systems, each of which may be connected to one another via one or more networks. The systems may also be connected to one another via a direct connection, for example, using a cable. The depicted systems include an FO system 113, a fulfillment messaging gateway (FMG) 115, a workforce management system (WMS) 119, devices 119A-C, and users 350. FMG 115, WMS 119, devices 119A-C, and users 350 shown in FIG. 4 correspond to their respective counterparts in FIGS. 1A and 3B and will not be described again here.

FO system 113, on the other hand, is shown in more detail with its component systems. In some embodiments, FO system 113 comprises an order database 411, an inventory database 412, a FC configurations database 413, and a batch generator 414. In these embodiments, components of FO system 113 (i.e., order database 411, inventory database 412, FC configuration database 413, and batch generator 414) may be implemented as one or more functional units performed by one or more processors based on instructions stored in the one or more memories. Alternatively, components of FO system 113 may be implemented as one or more computer systems communicating with each other via a network. In this embodiment, each of the one or more computer systems may comprise one or more processors, one or more memories (i.e., non-transitory computer-readable media), and one or more input/output (I/O) devices. In some embodiments, each of the one or more computer systems may take the form of a server, general-purpose computer, a mainframe computer, a special-purpose computing device such as a GPU, laptop, or any combination of these computing devices.

Order database 411, inventory database 412, and FC configuration database 413, in some embodiments, may each be implemented as one or more computer systems that collect, accrue, and/or generate various data accrued from other systems described above. In other embodiments, order database 411, inventory database 412, and FC configuration database 413 may be implemented as a single system of database that store information corresponding to each database in different portions of its storage space (e.g., non-transitory computer-readable medium). In some embodiments, the databases may include cloud-based databases or on-premise databases comprising one or more hard disk drives, one or more solid state drives, or one or more non-transitory memories.

Regardless of the implementation, each component may be dedicated to storing order information, inventory information, and FC configuration information, respectively. More specifically, order database 411 may store order information from external front end system 103 as customers place orders for one or more items in the inventory. An order information, for example, may comprise an order identifier, a list of item identifiers 321 ordered by the customer, ordered quantity for each item respectively, customer contact information, payment information, or the like.

Inventory database 412 may store item information of individual items in picking zone 209 of FIG. 2. An item information, for example, may comprise a list of item identifiers 321 grouped by individual FC, their corresponding quantity in stock by FC, their location identifiers 311 within each FC, corresponding item's dimensions, weight, and handling instructions (e.g., fragile, perishable, refrigerated, frozen), or the like. In some embodiments, item information may be updated or generated as items in picking zone 209 are replenished by items are received from sellers at inbound zone 203 of FIG. 2 and as they are picked by pickers at picking zone 209 and shipped out to customers from camp zone 215. Various aspects of item information may be updated frequently as individual item identifiers are scanned at different locations within FC 200 and the information are processed by networked systems (e.g., transportation system 107, SOT system 111, WMS 119) described above with respect to FIG. 1A.

Still further, FC configuration database 413 may store FC configuration information of individual FCs. FC configuration information, for example, may comprise FC specific information comprising available types and numbers of cart 340, available types and numbers of container 330, specifications of transport systems 214 such as weight limit, current number of pickers 350 working at each FC, or the like. In some embodiments, FC configuration information may be collected and updated from time to time as new FCs are built or existing FCs are modified to, for example, add more types and numbers of cart 340 or container 330, or new transport systems 214 are installed.

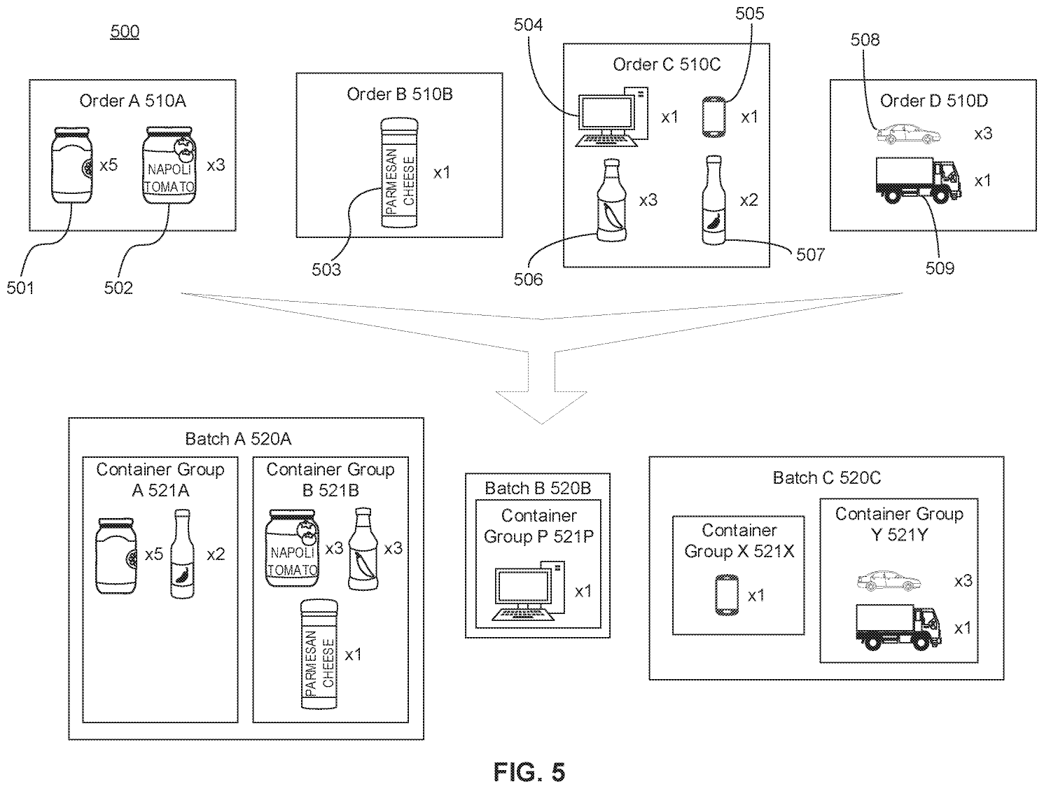

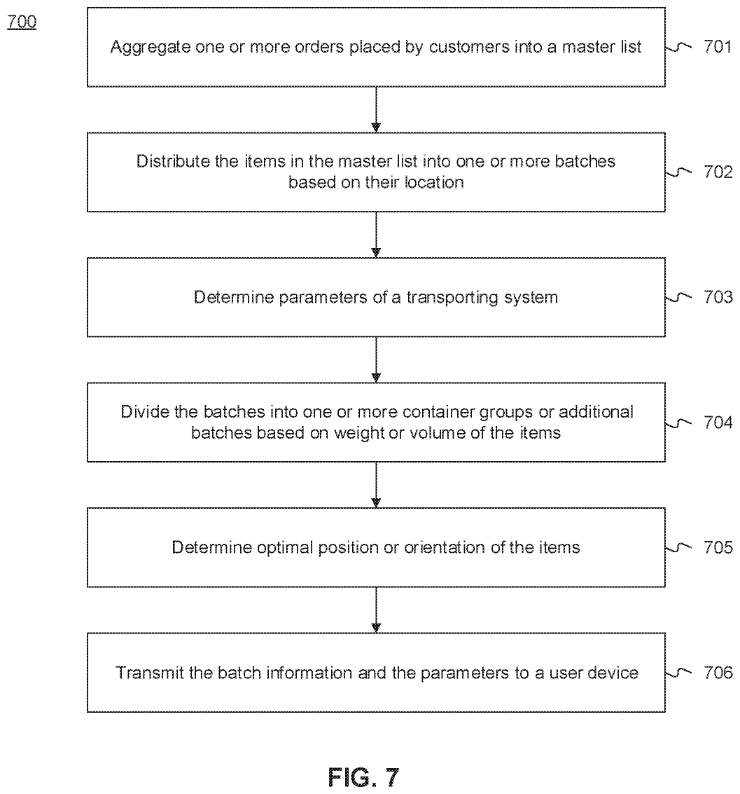

Batch generator 414, in some embodiments, may include one or more computing devices configured to aggregate order information from order database 411 and distribute them in batches to picker 350 based on item information from inventory database 412 and FC configuration information. The functions of batch generator 414 are described below in more detail with respect to FIGS. 5 and 7.

FIG. 5 is an illustration of an exemplary order distribution process 500 that aggregates multiple orders into batches. In this example, order A 510A, order B 510B, order C 510C, and order D 510D may be aggregated by batch generator 414 and distributed into batch A 520A, batch B 520B, and batch C 520C. The number of orders and batches, as well as the items illustrated therein, are only exemplary and batch generator 414 may aggregate any number of orders with any combination of items and distribute them into any number of batches as necessary.

In FIG. 5, order A 510A may comprise item identifiers 321 corresponding to a lemonade 501 and a tomato sauce 502 with quantities of five and three, respectively. Order B 510B may comprise item identifier 321 corresponding to a grated cheese 504 with a quantity of one. Order C 510C may comprise item identifiers 321 corresponding to a desktop 504, a toy tablet 505, a hot sauce 506, and a chili sauce 507 with quantities of one, one, three, and two, respectively. Order D 510D may comprise item identifiers 321 corresponding to a toy car 508 and a toy truck 509 with quantities of three and one, respectively.

Batch generator 414 may combine all item identifiers 321 and distribute them into batches A-C 520A-C based on, for example, their respective location identifier 311. For example, batch A 520A may contain item identifiers 321 corresponding to location identifiers 311 associated with an area in picking zone 209 that store grocery items. Similarly, batch B 520B and batch C 520C may contain item identifiers 321 corresponding to location identifiers 311 associated with areas in picking zone 209 that store electronics and toys, respectively. In some embodiments where orders A-D 510A-D contain an amount of items (whether by volume, weight, or quantity) associated with a particular area in excess of a predetermined maximum batch size, batch generator 414 may distribute the items into more than one batches. In some embodiments, each batch may be associated with a particular type of cart 340 and the maximum batch size may be determined based on the size of available types of cart 340.

Batch generator 414 may further divide item identifiers 321 assigned to a particular batch into one or more container groups. For example, item identifiers 321 assigned to batch A 520A may further be divided into container group A 521A and container group B 521B; and item identifiers 321 assigned to batch C 520C may be divided into container group X 521X and container group Y 521Y. Alternatively, all item identifiers 321 of a batch such as batch B 520B may be assigned to a single container group such as container group P 521P.

In some embodiments, the decision on whether to split item identifiers 321 of a batch may be based on a number of factors associated with the items corresponding to item identifiers 321, such as their total weight, total volume, individual shapes, and the like. Batch generator 414 may compare the factors to dimensions and/or weight capacity of each container 330 and split item identifiers 321 when a predetermined maximum container group size is reached. For example, container group A 521A and container group B 521B may each contain item identifiers 321 for lemonade 501 and chili pepper 507; and tomato sauce 502, hot sauce 506, and grated cheese 503, respectively. In further embodiments where a batch is associated with too many items that a maximum number of container groups for a particular cart 340 associated with the batch is reached, batch generator 414 may create a new batch and associate the excess item identifiers 321 to the new batch. The new batch may similarly be subject to splitting into one or more container groups as described above.

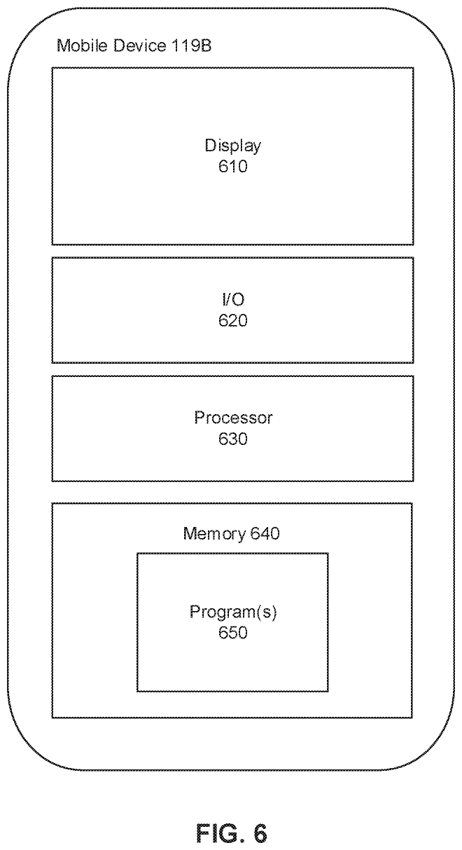

FIG. 6 is a schematic block diagram illustrating an exemplary user device such as mobile device 119B. Mobile device 119B may comprise display 610, I/O device 620, processor 630, and memory 640. While FIG. 6 depicts mobile device 119B, one of skill in the art will understand that other devices may be implemented in a similar manner (e.g., tablet 119A or computer 119C).

Mobile device 119B may be configured with storage that stores one or more operating systems that perform known operating system functions when executed by one or more processors. By way of example, the operating systems may include Microsoft Windows, Unix, Linux, Android, Apple Mac OS, iOS, or other types of operating systems. Accordingly, examples of the disclosed invention may operate and function with computer systems running any type of operating system. Mobile device 119B may also include communication software that, when executed by a processor, provides communications with network, such as Web browser software, tablet or smart hand-held device networking software, etc.

Mobile device 1198 may include a display 610. Display 610 may include, for example, liquid crystal displays (LCD), light emitting diode screens (LED), organic light emitting diode screens (OLED), a touch screen, and other known display devices. Display 610 may display various information. For example, display 610 may display how many containers and carts are necessary for a batch. Display 610 may display touchable or selectable options for a user (e.g., picker 350) to select and may receive user selection of options through I/O device 620 such as a touchscreen.

I/O devices 620 may include one or more devices that allow mobile device 1198 to send and receive information from a user or another device. I/O devices 620 may include various input/output devices, such as a scanner, a camera, a keyboard, a mouse-type device, a gesture sensor, an action sensor, a physical button, an oratory input, a touchscreen, etc. I/O devices 620 may also include one or more communication modules (not shown) for sending and receiving information from other components in WMS 119 by, for example, by establishing wired or wireless connections between mobile device 1198 and WMS 119.

Mobile device 1198 may include at least one processor 630, which may be one or more known computing processors, such as those described with respect to FO system 113 in FIG. 4. Processor 630 may execute various instructions stored in mobile device 1198 to perform various functions, for example, processing information related to item 320 or container 330 received from I/O device 620.

Mobile device 1198 may include a memory 640, which may be a volatile or non-volatile, magnetic, semiconductor, tape, optical, removable, non-removable, or other type of storage device or tangible (i.e., non-transitory) computer-readable medium. Memory 640 may store one or more programs 650. Programs 650 may include operating systems (not shown) that perform known operating system functions when executed by one or more processors. Disclosed examples may operate and function with computer systems running any type of operating system.

Programs 650 may be a workflow management program. The workflow management program may control a picking operation in FC 200 by providing instructions to workers. Program 650 may be executed by processor 630 to perform processes related to fulfilling batches, including, but not limited to, receiving an identifier associated with a batch from mobile device 1198, displaying the determined number of containers through mobile devices 1198, receiving a container identifier from user device, and retrieving a list of one or more items associated with a batch.

FIG. 7 is a flowchart of an exemplary computerized process 700 for efficient distribution of orders based on system parameters. In some embodiments, process 700 may be performed by FO system 113 using information from other networked systems as described above. More specifically, process 700 may be performed by batch generator 414 using information from order database 411, inventory database 412, and FC configuration database 413. In some embodiments, the scope of process 700 may be limited to a particular FC, where FO system 113 may perform process 700 using FC configuration information of the particular FC and item information associated with the particular FC (e.g., quantity and location of items stored at the FC). Process 700 for other FCs may be performed by another FO system 113 associated with respective FCs or by the same FO system 113 in a separate instance of process 700. Furthermore, FO system 113 may repeat steps 701-706 multiple times in a given period of time for each FC 200 as customers place orders via external front end system 103. FO system 113 may also perform multiple instances of steps 701-706 for one or more groups of orders, where the instances may individually be at various steps at any given moment.

At step 701, batch generator 414 may aggregate one or more orders placed by customers via external front end system 103. Aggregation, in some embodiments, refers to collecting order information from order database 411 by their order identifier as new order information are generated. As it aggregates the orders, batch generator 414 may also disassemble the orders down to product-level, where the list of item identifiers 321 in each order information are combined into one master list of item identifiers 321 along with respective order quantity of each item. This aggregation of orders may continue until a predetermined event, at which point batch generator 414 may perform step 702 to distribute item identifiers 321 on the master list into one or more batches. Batch generator 414 may also update the set of order information associated with item identifiers 321 in the master list to include the one or more batches. In some embodiments, batch generator 414 may also start another aggregation with the next set of orders placed by customers, while the master list is processed through steps 702-706.

The predetermined event, in some embodiments, may be time based where batch generator 414 stops aggregating order information into a master list at a predetermined interval. In other embodiments, the predetermined event may be triggered manually by a user (e.g., a manager at an FC), via an I/O device connected to FO system 113, by inputting a signal instructing batch generator 414 to stop aggregating a current set of orders. Still further, in other embodiments, batch generator 414 may trigger the predetermined event automatically based on FC configuration information such as the number of pickers available. For example, batch generator 414 may trigger the predetermined event when the master list contains a sufficient quantity of items to create enough number of batches to be assigned to each picker. In some embodiments, batch generator 414 may trigger the predetermined event when the number of batches that can be created is greater than the number of available pickers by a predetermined factor (e.g., 1.5).

At step 702, batch generator 414 may distribute item identifiers 321 in the master list into one or more batches based on corresponding item information. In some embodiments, the goal of such aggregation and distribution (i.e., reorganization) of items may be to allow a more efficient retrieval (i.e., picking) of the items from picking zone 209 compared to having each picker retrieve all items of an order regardless of where the items may be stored. Assigning batches associated with a particular area in picking zone 209 to particular pickers may allow the pickers to become familiar with locations of items, increasing their speed, and/or reduce a distance a picker must move in order to finish a batch.

In some embodiments, batch generator 414 may divide item identifiers 321 based on their respective location identifier 311, where item identifiers 321 corresponding to items that are located close together based on their respective location identifier 311 are grouped together. In some embodiments, picking zone 209 may be divided into one or more areas, each of which are assigned to one or more pickers, and batch generator 414 may divide item identifiers 321 based on where corresponding location identifiers 311 fall within the areas. As described above, in some embodiments, batch generator 414 may further divide a batch into more than one batches based on a type of cart 340 available at a particular FC. In further embodiments, batch generator 414 may also divide item identifiers 321 based on predetermined parameters such as minimum batch size, maximum batch size, or the like, which may be retrieved from FC configuration database 413.

At step 703, batch generator 414 may determine parameters of a transporting system available at the particular FC. In some embodiments, the transporting system may include at least one of carts 340, containers 330, and transport mechanism 214 described above. Accordingly, the parameters of the transporting system may include various aspects of each system, such as an available number and type of carts 340, an available number and type of containers 330, and a type of transport mechanism 214. Furthermore, parameters associated with cart 340 may comprise at least one of its weight capacity and dimensions of its compartments or cargo space. Similarly, parameters associated with a container 330 may comprise at least one of its weight capacity and dimensions of its storage compartment. Parameters of transport mechanism 214 may comprise at least its weight capacity. In some embodiments, batch generator 414 may retrieve these parameters from FC configuration database 413.

At step 704, using the parameters determined at step 703 above, batch generator 414 may divide each batch into one or more container groups or additional batches in a manner described above with respect to FIG. 5. More specifically, batch generator 414 may retrieve dimensions and weight of each item corresponding to item identifiers 321 assigned to a particular batch and assign each item identifier 321 to a container group until a weight capacity or a volume capacity of a corresponding container 330 or a weight capacity of transport mechanism 214 is reached, whichever occurs first. In some embodiments, batch generator 414 may apply a predetermined ratio to each of the capacities. For example, instead of assigning item identifiers 321 to a container group until the weight capacity of the corresponding container 330 is reached, batch generator 414 may assign them until 70% of the weight capacity is reached. The predetermined ratio may be a uniform ratio that is applied to each capacity (i.e., weight capacity of container 330, volume capacity of container 330, and weight capacity of transport mechanism 214) or the ratio may be different for each capacity or type of transporting system.

One or more items of an order may have an irregular shape, which may cause corresponding container 330 to fill up more quickly than anticipated as a picker places actual items into container 330. In some embodiments, a heavy item placed above a fragile or soft item placed may also damage the fragile or soft item. Therefore, at step 705, batch generator 414 may determine, based on item information retrieved from inventory database 412, an optimal position or orientation of each item within container 330 using, for example, the considerations identified above. Alternatively or additionally, batch generator 414 may also determine the optimal positions or orientations by using other known or conventional methods of packing multiple items as well.

Based on the container groups determined at step 704 above, batch generator 414 may determine a number and type of container 330 and a type of cart 340 required for a particular batch. This information may enable picker 350 to start a batch assigned to him or her with a right number and type of transporting instruments required for the batch, preventing picker 350 from having to make multiple trips back and forth within picking zone 209 because he or she ran out of space for carrying items 320. Accordingly, at step 706, batch generator 414 may transmit this information associated with a particular batch to WMS 119 and to a user device (e.g., devices 119A-C) belonging to a picker assigned to the particular batch. The user device may then display the information in a manner described above.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for efficient distribution of orders based on system parameters, the system comprising:
a memory storing instructions; and
at least one processor configured to execute the instructions for:
aggregating one or more orders comprising one or more quantities of a plurality of items, wherein aggregating the orders comprises at least one of aggregating the orders until a user input is received or aggregating the orders based on a number of available workers;
retrieving item information for each of the plurality of items from an inventory database;
assigning a subset of the items to a batch, wherein the items are assigned to one or more batches based on the item information and based on a weight capacity and a volume capacity of each of one or more containers of a transporting system;
determining one or more parameters of the transporting system for the one or more batches;
determining at least one of location or orientation of the items in the transporting system based on the parameters of the transporting system; and
transmitting, to a user device for display, the parameters of the transporting system;
wherein a subset of the items assigned to one or more batches is re-assigned to a new batch when any of the one or more batches includes an aggregate of items that exceeds the parameters of the transport system.

2. (canceled)

3. The computer-implemented system of claim 1, wherein assigning the subset of the items to the batch comprises assigning a first item to the batch based on at least one of location of the first item, dimensions of the first item, and a combined weight of the subset of the items.

4. The computer-implemented system of claim 1, wherein the parameters comprise at least one of a type of a container included in the transporting system; a number of the container included in the transporting system; and a carrying capacity of the transporting system.

5. The computer-implemented system of claim 1, wherein a combined weight of the subset of the items is less than a carrying capacity of the transporting system.

6. (canceled)

7. The computer-implemented system of claim 1, wherein assigning the subset of the items to the batch comprises:
assigning a portion of the subset of the items to a first container, wherein the subset of the items is assigned to one or more containers based on the weight capacity and the volume capacity.

8. The computer-implemented system of claim 7, wherein a total weight or a total volume of the portion of the subset of the items assigned to the first container is less than the weight capacity or the volume capacity of the first container by a predetermined ratio.

9. The computer-implemented system of claim 1, wherein the instructions further comprise transferring the batches from a first location to a second location using an automated transporting system.

10. The computer-implemented system of claim 9, wherein assigning the subset of the items to the batch is based on a weight capacity of the automated transporting system.

11. A computer-implemented method for efficient distribution of orders based on system parameters, the method comprising:
aggregating one or more orders comprising one or more quantities of a plurality of items, wherein aggregating the orders comprises at least one of aggregating the orders until a user input is received or aggregating the orders based on a number of available workers;
retrieving item information for each of the plurality of items from an inventory database;
assigning a subset of the items to a batch, wherein the items are assigned to one or more batches based on the item information and based on a weight capacity and a volume capacity of each of one or more containers of a transporting system;
determining one or more parameters of the transporting system for the one or more batches;
determining at least one of location or orientation of the items in the transporting system based on the parameters of the transporting system; and
transmitting, to a user device for display, the parameters of the transporting system;
wherein a subset of the items assigned to one or more batches is re-assigned to a new batch when any of the one or more batches includes an aggregate of items that exceeds the parameters of the transport system.

12. (canceled)

13. The computer-implemented method of claim 11, wherein assigning the subset of the items to the batch comprises assigning a first item to the batch based on at least one of location of the first item, dimensions of the first item, and a combined weight of the subset of the items.

14. The computer-implemented method of claim 11, wherein the parameters comprise at least one of a type of a container included in the transporting system; a number of the container included in the transporting system; and a carrying capacity of the transporting system.

15. The computer-implemented method of claim 11, wherein a combined weight of the subset of the items is less than a carrying capacity of the transporting system.

16. (canceled)

17. The computer-implemented method of claim 11, wherein assigning the subset of the items to the batch comprises:
assigning a portion of the subset of the items to a first container, wherein the subset of the items is assigned to one or more containers based on the weight capacity and the volume capacity.

18. The computer-implemented method of claim 17, wherein a total weight or a total volume of the portion of the subset of the items assigned to the first container is less than the weight capacity or the volume capacity of the first container by a predetermined ratio.

19. The computer-implemented method of claim 11 further comprising transferring the batches from a first location to a second location using an automated transporting system, wherein assigning the subset of the items to the batch is based on a weight capacity of the automated transporting system.

20. A computer-implemented system for efficient distribution of orders based on system parameters, the system comprising:
a memory storing instructions; and
at least one processor configured to execute the instructions for:
aggregating one or more orders comprising one or more quantities of a plurality of items, wherein aggregating the orders comprises at least one of aggregating the orders until a user input is received or aggregating the orders based on a number of available workers;
retrieving item information for each of the plurality of items from an inventory database;
assigning a first subset of the items to a first batch, wherein the items are assigned to one or more batches based on item information;
determining one or more parameters of a transporting system for the first batch;
determining whether the items assigned to any of the one or more batches exceeds a weight capacity or volume capacity of the transporting system, and re-assigning one or more items to a new batch when the weight capacity or volume capacity are exceeded;
determining at least one of location or orientation of the first set of items in the transporting system based on the parameters of the transporting system;
transmitting, to a user device for display, the parameters of the transporting system;
receiving, from the user device, a first item identifier associated with a first item among the first subset of items; and
transmitting, to the user device for display in response to the first item identifier, at least one of the location or the orientation of the first item as placed in the transporting system.
